(19) United States
(12) Patent Application Publication
(10) Pub. No.: US 2011/0138692 A1
(43) Pub. Date: Jun. 16, 2011

(54) AUTOMATIC SLIDING DOOR SYSTEM

(75) Inventor: Robert Auke Lemstra, Alkmaar (NL)

(73) Assignee: Intradoor Inc., Rochester, NY (US)

(21) Appl. No.: 12/639,992

(22) Filed: Dec. 16, 2009

(51) Int. Cl. E05F 15/14; E05F 15/10

(52) U.S. Cl. 49/349; 49/358

(57) ABSTRACT

An automatic door driving system that includes a motor, a driving member and a belt cooperating with the driving member. The belt is attached to a door panel to be moved. The motor, the driving member and the endless belt are disposed in a footprint defined by the width and dept of the door frame.

### BACKGROUND OF THE INVENTION

The present invention relates to doors. More specifically, the present invention relates to automatic sliding doors for use in residential and commercial buildings.

### TECHNICAL FIELD

Sliding doors have well known uses for residential and commercial applications. Specifically, many doors are known that cooperate with a track to slide between open and closed positions to allow and preclude access into a building or between rooms in a building. A specific example of an outside sliding door is a sliding glass door while a specific example of an inside sliding door is a pocket door.

Conventionally, when a door panel is arranged in cooperation with a track or other guiding mechanism, a user manually opens and closes the door by contacting the door panel or a handle fixed to the door panel and sliding the door along the track. However, in many applications, it is preferred that the door be automatically moveable. For example, some users may be unable to open and close sliding doors manually, or it may be desirable to selectively or automatically open or close the doors, for example, in a fire emergency or the like.

While there conventional automatic door operating devices do exist, such devices tend to be bulky and require extensive redesigns of the walls surrounding the door opening. Thus, there is a need in the art for a low-profile, concealed automatic door opener for use with sliding door panels. Moreover, there is a need in the art for an automatic door opening system that disengages in the event of a power failure such that an individual can easily open or close the door manually.

### SUMMARY OF THE INVENTION

The present invention remedies the foregoing needs in the art by providing an automatic door driving system that includes a motor, a driving member and a belt cooperating with the driving member. The belt is attached to a door panel to be moved. The motor, the driving member and the endless belt are disposed in a footprint defined by the width and dept of the door frame.

In another aspect, the present invention provides an automatic door driving system comprising a header adapted to span an opening between spaced vertical support members, and defining a mounting space, a motor disposed within the mounting space, a driving member disposed in the mounting space, and an endless belt disposed within the mounting space.

An understanding of these and other aspects, features, and objects of the invention may be had with reference to the following description and accompanying figures, in which the preferred embodiments of the invention are described and shown.

### BRIEF DESCRIPTION OF THE DRAWING FIGURES

FIG. 1 is a front elevation of a sliding door system according to a preferred embodiment of the invention.

FIG. 2 is a sectional view of the sliding door system illustrated in FIG. 1, taken along section line C-C.

FIG. 3 is a side elevation view of a door driving system as used in the sliding door system illustrated in FIG. 1.

FIG. 4 is a top view of the door driving system illustrated in FIG. 3.

FIG. 5 is a bottom view of the sliding door system illustrated in FIG. 1.

Throughout the Figures, the same reference numerals are used to designate the same parts.

### DETAILED DESCRIPTION OF THE PREFERRED EMBODIMENTS

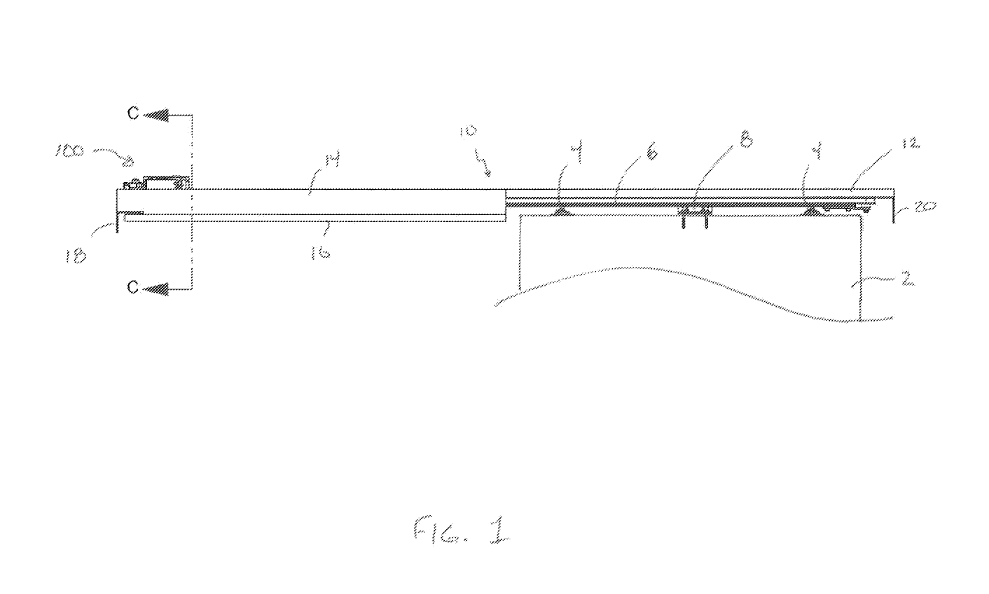

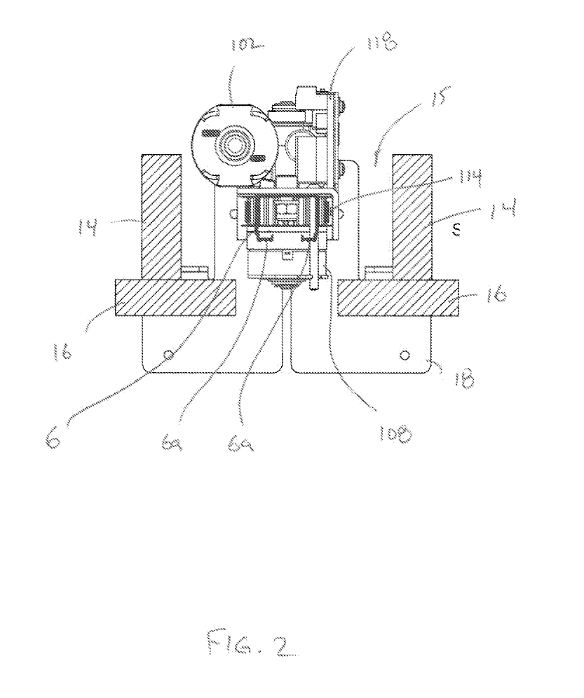

Preferred embodiments now will be described with reference to the figures. As illustrated in FIG. 1, a sliding door system includes a door panel 2 suspended from a track 6. More specifically, a top of the door 2 is provided with a plurality of rollers 4 that are fixed to the top of the door panel 2 and that cooperate with the track to suspend the door from the floor. As is conventionally known, the rollers 4 are free to slide along the track 6 in a predefined fashion. As illustrated in FIG. 2, the track 6 of the present invention has two bottom groves 6a within which the roller 4 are contained. The rollers 4 roll longitudinally along the track as confined within the grooves 6a.

The invention is not limited to the track and roller arrangement just described, but as will be readily apparent to those of ordinary skill in the art, door panels having other sliding arrangements are equally useable in the invention. As also will be appreciated, although the invention is shown as suspending the door panel from the top, a track or the like may alternatively or additionally be provided at the bottom of the door to maintain alignment of the door panel.

The door is also provided with a door mounting bracket 8. As will be described in more detail below, the door mounting bracket 8 is used to mount the door panel 2 to an endless belt 110.

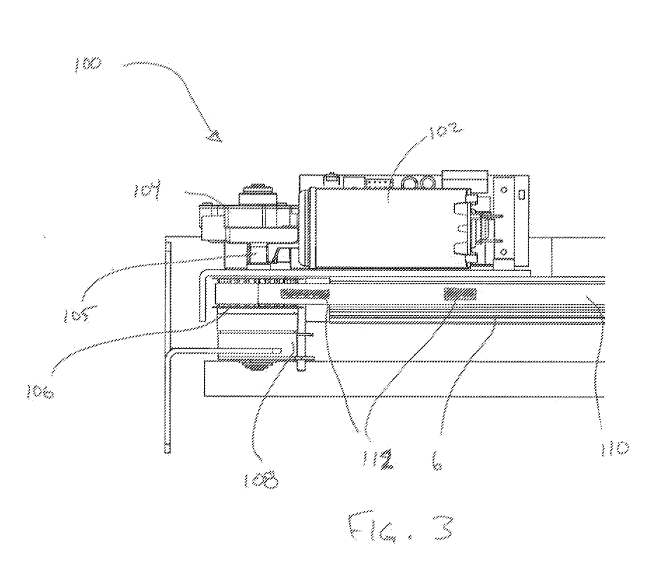

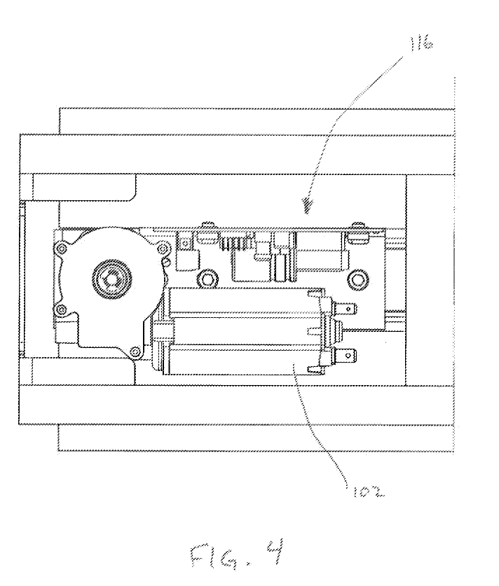

As also illustrated in FIG. 1, the present invention includes an automatic door operating system 100. The system 100 now will be described in detail with specific reference to FIGS. 2-4.

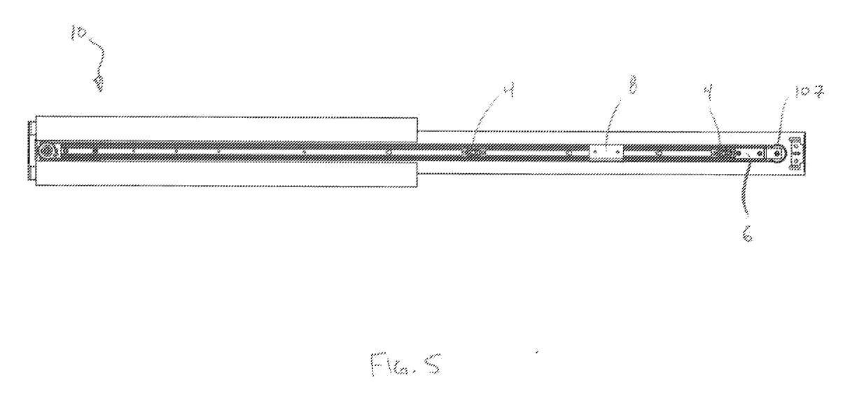

The automatic door operating system 100 generally includes a motor 102 in communication with a drive train 104. The shaft of the motor 102 is arranged to rotate about a horizontal axis and the drive train 104 converts this rotation by the horizontal axis to rotation of a vertical shaft 105 about a vertical axis. The vertical shaft 105 drives a pulley 106 or other similar driving member and is attached to a clutch 108. An endless belt 110 is driven by the pulley and extends along the length of the track 6 on a first side of the track 6 to a second pulley 107 (shown in FIG. 5) and returns to the pulley 106 along the opposite side of the track 6. Because the door panel 2 is fixed to the belt 110 at a predetermined location by virtue of the mounting bracket 8, movement of the belt results in sliding of the door panel 2 along the track 6. In the illustrated embodiment, the belt is arranged to move in a substantially horizontal plane. The inventors have found such an arrangement to be preferred, although it is appreciated that the pulleys could be arranged to drive the belt in a vertical plane.

Also in the illustrated embodiment, the belt 110 has teeth or grooves that cooperate with teeth or grooves on the pulley 106. However, such an arrangement is not required. For example, the pulley may be replaced with some alternative known driving member such as a drum or gear, and the endless belt would thus be replaced with some known structure that cooperates with that driving member, such as an alternate belt, a rope or a chain. As will be appreciated by those of ordinary skill in the art, any arrangement in which rotation of the driving member results in movement of the door panel can be used in the system without deviating from the spirit of the invention.

The clutch 108 is an electromagnetic clutch that selectively engages and disengages the pulley 106 from the vertical output shaft 105 of the drive train 104, as will be described in more detail below.

In operation, the motor is activated to move the door between the open and closed positions. More specifically, the door actuating system also is provided with an integrated circuit board 116 and associated wirings such that a signal provided by a user is converted to an instruction to the motor to begin rotation. An instruction also is provided to the electromagnetic clutch to engage the vertical shaft 105 with the pulley 106, thereby driving the pulley 106. Driving the pulley 106 results in movement of the belt 110. Because the belt 110 is attached to the door panel, the door panel also moves.

Stopping the door in the open or closed position can be accomplished in a number of ways. In the preferred embodiment, the belt 110 is provided with a number of markings 112. The markings 112 are spaced along the belt to be sensed by a sensor 114. In the most simple arrangement, two markings 112 are provided, one associated with each of the open and closed position of the door. When the marking is sensed 112, either the clutch disengages the pulley from the vertical shaft, power to the motor is cut off, or both. Because inertia of the moving door may continue to move the door panel along the track even after driving is stopped, a hard stop (not shown) or the like may be provided to be contacted by the door panel, the roller or both. A breaking feature also could be provided by the clutch and/or the motor to stop the door panel.

In another preferred embodiment, a total of four markings 112 are provided, two associated with each of the open position and the closed position. In this arrangement, the two markings associated with either of the positions are sensed in succession, such that the first marking sends a signal to slow the speed of the door, either by slowing the speed of the motor or by selectively disengaging the clutch, and sensing the second marking sends a signal to stop movement of the door. In this way, operation of the door is better controlled and is smoother.

Also in the preferred embodiment, the markings are moveable by the user or the installer on the belt to optimize operation of the door. For example, if the user desires the door to slow sooner, the spacing between the two markings associated with each of the positions can be spaced further. Similarly, if a more abrupt stop is desirable, the marking can be placed closer together. Although the movable markings can be made in any number of ways, in the preferred embodiment, the markings have an adhesive back that are readily adhered to and removed from the belt.

Any number of sensors can be used. In the preferred embodiment, the sensor senses a contrast in colors as a triggering event. Thus, if the belt is a dark color, such as black, white or light markings would be readily sensed by the sensor. Similarly, dark or black markings on a white belt would be sensed. Other conventional sensor arrangements could alternatively be used, including sensors that detect a distance travelled by the belt.

As described, the present invention provides a low-profile automatic door operating system mounted proximate an end of the track 6. The system requires minimal headroom owing to the arrangement of the motor 102 and the drive train 104. Moreover, because the clutch 108 is disposed on a side of the pulley 106 opposite the drive train 104, the height of the automatic door operating system is significantly reduced compared to known prior art systems.

Because of its compact nature, the entire system can be contained and concealed within a header structure 10. As shown in FIG. 1 the header structure 10 includes a top plate 12, vertical members 14 and horizontal members 16. The header structure 10 preferably is designed to be supported on opposite sides by vertical door framing members (not shown) that define the width of the door frame. Thus, the header and all parts of the system are contained within the width of the door frame.

As shown in greater detail in FIG. 2, the horizontal members 16 are arranged substantially on the same plane, spaced from each other. The vertical members 14 extend upwardly, each from one of the horizontal members 16. Above the horizontal members and between the vertical members 14 is defined a mounting space 15 in which the automatic door operating system 100 and the track 6 are disposed. In a preferred embodiment, outside surfaces of the vertical members 14 are spaced a predetermined distance substantially corresponding to the wall thickness of the structure in which the door is to be mounted. The horizontal members 10b also are sufficiently spaced to allow for movement of the door panel therebetween.

In the illustrated embodiment, a first mounting bracket 18 is arranged on one end of the header 10 and a second mounting bracket 20 is disposed on the other end of the header 10. The header preferably is mounted to vertical support members, e.g., wall studs, using fasteners through the brackets 18, 20. Moreover, the top plate 12 can be fastened to an existing door header (not shown). As illustrated the top plate 12, and the vertical and horizontal members 14, 16 span only a portion of the distance between the brackets 18, 20, although any or all of these features could be extended the entire length of the device. In the illustrated embodiment, the top plate is truncated because the automatic door operating system 100 extends above the vertical members. This could require forming a cutout in an existing header structure. In an alternative embodiment, the vertical members could be lengthened to extend above the door operating system, although such an arrangement could lower the top of the door slightly, in the event that the top plate is abutted to an existing header associated with the door.

The header 10 preferably is longer, i.e., the distance between the brackets 18, 20 is greater than, the combined length of the track and automatic door operating system, such that the track 6 and the automatic door operating system 100 are contained completely therein. Moreover, and as noted above, the length of header corresponds to the width of the door frame. Thus, the entire system fits within a footprint of the door frame

In another embodiment, the vertical and horizontal members could be extended along the entire distance between the brackets 18 and 20, and the vertical and horizontal members could actually form the header for the door. In such an alternative embodiment, the header 10 could be set upon spaced studs that define sides of the door frame, with the vertical members 14 being the header forming the top of the door frame. Above the header structure 10, cripplers or cripple studs can preferably then be attached to the tops of the vertical members 14 or to the top plate 12. Also in this embodiment, the vertical members 14 could be heightened so as to extend above the automatic door operating system 100, in which case a crippler could be used directly above the automatic door operating system.

As a feature of the invention, the mounting space is no deeper, i.e. the distance between the vertical walls is no more than the width of the walls (and preferably no wider than the studs forming the walls) of the building (typically constructed from 2×4 or 2×6 studs). Moreover, the mounting space does not extend beyond the width of the door opening. That is, the door operating system of the present invention is formed within a footprint of the door frame. Thus, with the exception of providing external power or controls to the automatic door operating system, no part of the system is outside the footprint of the door frame. As noted above, the vertical members 14 of the header structure 10 preferably are spaced a distance corresponding to the width of the studs or walls used in the building, so the automatic door fits seamlessly into the building. For new construction, the header structure is mounted to two vertical members or studs in the same way a conventional header is mounted.

Although any number of components can be used in the system without deviating from the scope and spirit of the invention, in the preferred embodiment, the motor is commercially available from Nidec, as part no. 404.166 GPMG. The clutch is available from Deltran, although the present clutch was specifically designed for use in this system. Specifically, because of the requirement that the system be compact for housing in the header space of the sliding door, the clutch was modified to have a keyed shaft instead of a shaft attached using set screws, to reduce the height of the clutch.

The motor preferably is mounted on a substantially L-shaped mounting bracket 118. The integrated circuit board 116 also is mounted on the L-shaped mounting bracket 118. Other mounting structures could alternatively be used, although the illustrated embodiment provides the compact system unique to the present invention.

The present invention also provides other benefits over the conventional art. For example, because the clutch is electromagnetic, it can be engaged and disengaged for other purposes. For example, if it is desirable that the door also be manually operable, the system is configured such that no electrical current is applied to the clutch when the door is not moving. Because the pulley is not engaged with the vertical shaft, in this state the pulley is readily rotatable, and thus the door can be moved manually. In still other applications, it may be desirable to provide a sort of lock in one or both of the open and closed positions. By applying an electrical current to the electromagnetic clutch, the pulley is engaged with the motor. Accordingly, to operate the door manually, a user would have to move the door with sufficient force to overcome the force of the motor. Also because the clutch disengages when no electrical current is supplied, it should be appreciated that the doors would be manually moveable in case of an emergency that cut power to the building.

Also to account for emergencies, the doors are configurable to be operated remotely. For example, if it is desirable to open or close all or certain doors from a central location, appropriate controls can readily be included in the integrated circuit board. This is particularly useful to comply with fire requirements or to quarantine specific rooms, for example. While all doors made be hard-wired from a central location, in this application, the circuit board preferably also includes a radio frequency (RF) module or other wireless means. In this manner, the door may be activated wirelessly from a remote location.

The foregoing embodiments of the present invention are provided as exemplary embodiments and presently known best modes for carrying out the invention. Modifications of these embodiments will be readily apparent to those of ordinary skill in the art. The invention is not intended to be limited by the foregoing embodiments, but instead is intended to be limited only by the appended claims.

1. An automatic door driving system comprising:
a motor;
a driving member arranged to be driven by the motor; and
an endless belt attached to a door panel slidable within a track between an open position and a closed position, the endless belt cooperating with the driving member such that when the driving member is driven by the motor, the endless belt moves the door panel in the track between the open position and the closed position,
the motor, the driving member and the endless belt being disposed in a footprint having a length that is less than the distance between the position of a first side of the door when the door is in the open position and the position of a second side of the door when the door is in the closed position.

2. The automatic door system of claim 1, further comprising a clutch arranged to selectively allow the driving member to be driven by the motor.

3. The automatic door system of claim 2, wherein the clutch is arranged on a side of the driving member opposite the side on which the motor is arranged.

4. The automatic door system of claim 1, wherein a shaft of the motor is disposed to rotate about a substantially horizontal axis and the driving member is disposed to rotate about a substantially vertical axis.

5. The automatic door system of claim 4, wherein the endless belt moves in a substantially horizontal plane.

6. The automatic door system of claim 1, further comprising a driven member spaced from the driving member and cooperating with the endless belt.

7. The automatic door system of claim 6, wherein the driving member and the driven member are arranged at opposite ends of the track.

8. The automatic door system of claim 6, further comprising a sensor for sensing a position of the belt to stop the belt at positions corresponding to the open and closed positions of the door.

9. The automatic door system of claim 8, wherein the endless belt comprises at least two sensed portions, one associated with each of the open position and the closed position of the door.

10. The automatic door system of claim 9, wherein the endless belt comprises two sensed portions associated with the open position of the door and two sensed portions associated with the closed position of the door.

11. The automatic door system of claim 10, wherein at least one of the two sensed portions associated with the open position of the door and at least one of the two sensed portions associated with the closed position of the door are movable along the endless belt.

12. The automatic door system of claim 11, wherein as the door is moved by the system from the closed position to the open position, a first of the two sensed portions associated with the open position is sensed and the velocity of the movement of door is slowed and then the second of the two sensed portions associated with the open position is sensed and movement of the door is stopped.

13. The automatic door system of claim 9, wherein the sensed portions are movable by a user along the endless belt.

14. The automatic door system of claim 2, wherein the clutch is an electromagnetic clutch.

15. The automatic door system of claim 14, wherein the application of an electrical current to the clutch engages the clutch with the driving member and the clutch is disengaged from the driving member in the absence of an electrical current.

16. An automatic door driving system comprising:
a header structure configured for attachment between studs in a building, the header structure having a substantial U-shaped including at least one horizontal member defining a top of a door opening and at least two vertical members extending upwardly relative to the horizontal member spaced from each other, a mounting space being defined above the horizontal member and between the vertical members;
a motor disposed within the mounting space;
a driving member configured to be driven by the motor, the driving member also being disposed within the mounting space; and
an endless belt disposed within the mounting space and adapted to be attached to a door panel movable between an open position and a closed position.

17. The automatic door driving system of claim 16, wherein the vertical members are arranged such that outer surfaces thereof are spaced a distance that is substantially the same as a width of the studs.

18. The automatic door driving system of claim 16, further comprising:
a track disposed in the mounting space and along which the door panel is movable.

19. The automatic door driving system of claim 16, further comprising a sensor for sensing a position of the endless belt.

20. The automatic door driving system of claim 19, further comprising sensed portions disposed on the endless belt and sensed by the sensor.
